(19) United States
(12) Patent Application Publication
(10) Pub. No.: US 2001/0012034 A1
(43) Pub. Date: Aug. 9, 2001

(54) METHOD AND APPARATUS FOR OPERATING A PRINTING DEVICE

(75) Inventor: WINTHROP D. CHILDERS, SAN DIEGO, IL (US)

Correspondence Address: HEWLETT-PACKARD COMPANY, INTELLECTUAL PROPERTY ADMINISTRATION, P.O. BOX 272400, FORT COLLINS, CO, 80528-9599, US

(73) Assignee: HEWLETT-PACKARD COMPANY

(21) Appl. No.: 09/302,612

(22) Filed: Apr. 30, 1999

(51) Int. Cl. B41J 2/21

(52) U.S. Cl. 347/43

(57) ABSTRACT

One aspect of the present invention is an inkjet printing device that is responsive to color description information for depositing colorants corresponding to the color description information on print media. The colorants are selected from a plurality of colorants associated with the inkjet printing device. The inkjet printing device includes a determination device for determining an out-of-ink condition indicative of exhaustion of one or more of the plurality of colorants. Also included is a control device responsive to the occurrence to an out-of-ink condition for depositing a colorant, different from the selected colorants, to be deposited on print media.

### CROSS REFERENCE TO RELATED APPLICATIONS

The present application is related to patent application entitled “Method And Apparatus For Balancing Colorant Usage” to Winthrop D. Childers, David M. Wetchler, Michael L. Bullock, and Jason Quintana filed herewith, attorney docket number 10971891-1, assigned to the assignee of the present invention and incorporated herein by reference.

### BACKGROUND OF THE INVENTION

The present invention relates to inkjet printing systems and, more particularly, to printing systems which make use of a technique for operating an inkjet printing system suitable for unattended printing whereby alternative colorants are automatically selected upon the occurrence of an out-of-ink condition.

Inkjet printers frequently make use of an inkjet printhead mounted within a carriage that is moved back and forth across print media, such as paper. As the printhead is moved across the print media, a control system activates the printhead to deposit or eject ink droplets onto the print media to form images and text. Ink is provided to the printhead by a supply of ink that is either carried by the carriage or mounted to the printing system not to move with the carriage. When the ink container is exhausted of ink, the ink container must be replaced. Replacement of the ink container may require the replacement of the printhead in the case where the printhead is integrated with the ink container or the ink container may be replaced separate from the printhead.

High quality color inkjet printers typically make use of black ink and color ink to form images on print media. The color ink is often three or more ink colors. Frequently inkjet printing systems make use of cyan, magenta, and yellow inks for forming color images. The black ink is used for text and color graphics where black is required.

Inkjet printers have been used in a wide variety of applications. The inkjet printer, because of its high quality and low cost, is well-suited to applications which have traditionally made use of electrophotographic printers. Unlike electrophotographic printing systems, inkjet printing systems provide color printing at a much lower cost than color electrophotographic printing systems. The integration of the inkjet printing system into monochrome printing applications such as facsimile machines has made it possible to provide additional functions to the facsimile that take advantage of the color printing capability of the inkjet printing system. As a result, systems have evolved such as the multi-function devices which typically include one or more of the following functions: printing, facsimile, scanning, and copying. These one or more of these functions typically make use of the color printing capability of the inkjet printing system.

Another growing application for inkjet printing devices is unattended printing applications where printing occurs without human intervention. An example of unattended printing is where information is routed to a printing device under software control. An example of this is where a host computer has a software application running on the computer that periodically sends information to the printer for printing. The host computer can further be connected to a server such as through a network such as an internet connection. The server having application software running thereon periodically forwards information to the host computer which is then printed on the printer. One example of this information delivery system for unattended printing, is the HP Instant Delivery system. HP is a registered trademark of the Hewlett-Packard Company, headquartered in Palo Alto, Calif. The HP Instant Delivery system forwards to users selected publications which are delivered automatically upon connection to the internet. This application software allows the selected information to be printed automatically on the printing device without user intervention.

One problem associated with use of inkjet printing devices for unattended printing applications is that one or more inks may become exhausted at an inopportune time. Particularly in the case where an inkjet printing device is part of a facsimile system that responds to facsimile encoded data to print a monochrome image. If the black ink is exhausted, the output of the printing system is either unintelligible or just not printed. This is particularly problematic for unattended printing applications where a low-ink warning may go unnoticed for a significant period of time. It may not be until facsimile images are retrieved that one realizes the facsimile is out of ink and images have been lost. This problem is further exacerbated if the intervals between image retrieval are lengthy.

There is an ever-present need for reliable printing systems that are well-suited for unattended printing applications. These inkjet printing systems should not only be reliable, but also minimize opportunity for loss of data or images in the event that ink is exhausted. Finally, these printing systems should have relatively low manufacturing costs, thereby providing better value to the consumer.

### SUMMARY OF THE INVENTION

One aspect of the present invention is an inkjet printing device that is responsive to color description information for depositing colorants corresponding to the color description information on print media. The colorants are selected from a plurality of colorants associated with the inkjet printing device. The inkjet printing device includes a determination device for determining an out-of-ink condition indicative of exhaustion of one or more of the plurality of colorants. Also included is a control device responsive to the occurrence to an out-of-ink condition for depositing a colorant, different from the selected colorants, to be deposited on print media.

Another aspect of the inkjet printing device of the present invention is that the plurality of colorants are black, cyan, yellow, and magenta inks. The color description information specifies a black color and wherein the selected colorant is black ink. Upon the determination that the black ink is exhausted, the control device selects at least one ink from the cyan, magenta, and yellow inks to be deposited on print media to form an image thereon.

Yet another aspect of the present invention is that the control device includes a facsimile control portion for receiving facsimile encoded data. The facsimile control portion, upon the receipt of facsimile encoded data, formats this data for the inkjet printing device for forming images on media. Upon receipt of facsimile encoded data, and upon the determination that the black ink is exhausted, the control device selects at least one of cyan, magenta, and yellow inks to be deposited on print media.

### BRIEF DESCRIPTION OF THE DRAWINGS

FIG. 1 depicts a perspective view of one exemplary embodiment of an inkjet printing system of the present invention.

FIG. 2 depicts a simplified schematic representation of the inkjet printing system shown in FIG. 1, illustrating removable print cartridges, each connected to a controller of the present invention.

FIG. 3 depicts a schematic block diagram of the inkjet printing system of FIG. 1 shown connected to a host.

FIG. 4 depicts a flow diagram illustrating the method of the present invention for selecting an alternative colorant upon a low ink condition.

FIG. 5 depicts a flow diagram illustrating the method of the present invention for operating a printing system of the present invention for printing facsimile encoded data.

### DETAILED DESCRIPTION OF THE PREFERRED EMBODIMENT

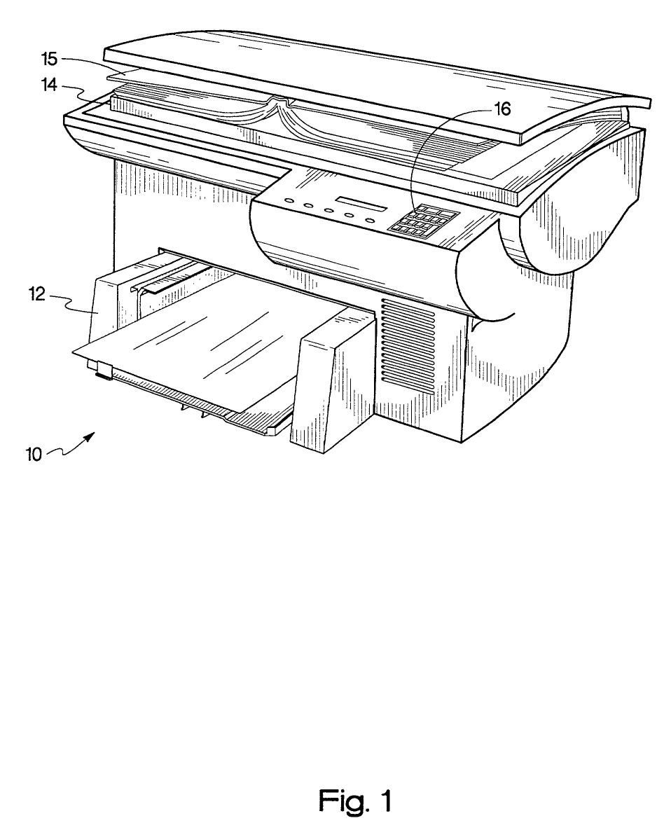

FIG. 1 depicts a perspective view of one exemplary embodiment of an inkjet printing system 10 of the present invention. The inkjet printing system 10 is capable of performing several different function referred to as a “multi-finction” device. The inkjet printing system 10 includes an input device 14 for creating an electronic representation of items placed into the input device 14. This input device 14 is commonly referred to as a scanner. The input device 14 is shown with a book 15 placed therein for converting images and text associated with the displayed pages into an electronic format. Once these images are captured in an electronic format, these images can be printed using the printer portion 12. Alternatively, these scanned images can be transferred to a host computer that may be electrically connected to a printing device 10. In addition, the printing device 10 can receive additional data through a data connection such as a phone line connection for receiving facsimile-encoded data. A control panel 16 is provided for controlling the printing device 10 and for selecting from one or more the various functions.

Functions which the printing device 10 is capable of performing include copying that is accomplished by scanning images in using the input device 14 and printing copies of those images using printer portion 12. A printing device 10 also operates as a printer by receiving image information from a host and printing this image information using printer 12. Finally, the printing system 10 is capable of operation as a facsimile machine by receiving faxes received on an input line such as a phone line and sending faxes by scanning documents to be faxed by using the input device 14, whereupon this image data is encoded and sent using the external phone line.

The printing system 10 may be configured in many different arrangements such as a printer only which would include only printer portion 12. Alternatively, the printing system 10 can be configured as a dedicated facsimile device configured for sending and receiving facsimile encoded data in which case an input device 14 is included for inputting data for sending facsimile information. In this configuration, the facsimile encoded data received by the dedicated facsimile are printed using the printer portion 12 to form images on media. There are numerous other applications where the printer portion 12 of the present invention is also suitable that are not discussed herein.

The printing system 10 of the present invention is well-suited for performing print operations without requiring intervention on the part of a user. For example, with the printing system 10 configured to receive facsimile encoded data, the printing system 10 awaits receipt of this data. Upon receipt of facsimile encoded data, the printing system 10 of the present invention can be configured to print this data on print media using printer portion 12. The printing system 10 of the present invention does not require any intervention to bring about the printing of the facsimile-encoded data. Because no intervention is required, the printing system 10 can be unattended.

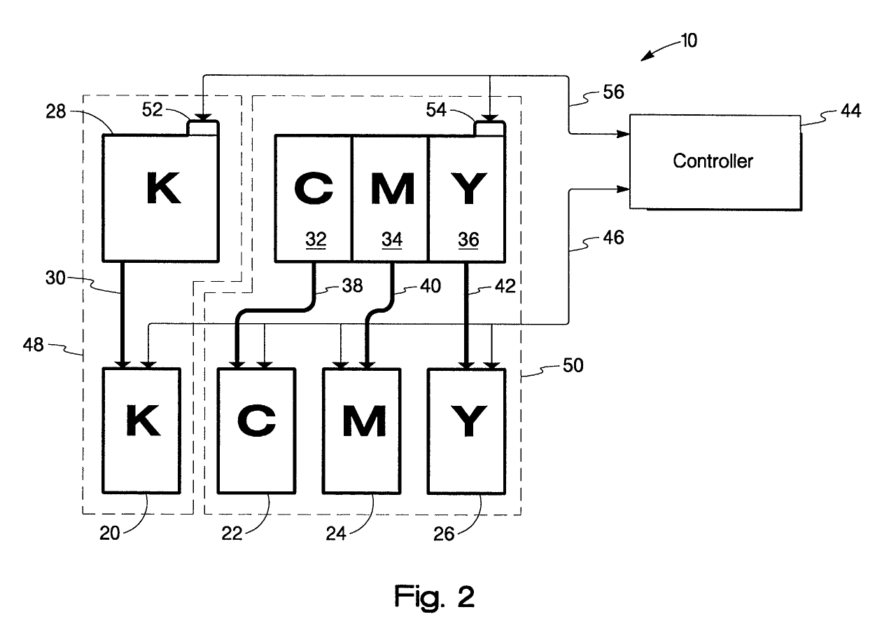

FIG. 2 depicts a simplified schematic representation of the inkjet printing system 10 of the present invention shown in FIG. 1. The inkjet printing system 10 includes a black printhead 20, designated with the letter K and a plurality of color printheads 22, 24, and 26. In one preferred embodiment, the color printheads 22, 24, and 26 correspond to cyan, magenta, and yellow inks designated by the letters C, M, and Y, respectively.

Also included in the inkjet printing system is a black ink container 28 fluidically coupled to the black printhead 20 by ink conduit 30. Similarly, a plurality of color ink containers 32, 34, and 36 corresponding to cyan, magenta, and yellow inks, respectively, are included that are fluidically coupled to respective printheads 22, 24, and 26 by fluid conduits 38, 40, and 42, respectively. A controller 44 selectively activates each of the printheads 20, 22, 24, and 26 to selectively eject or deposit ink on print media to accomplish printing. The controller 44 is linked to each of the printheads 20, 22, 24, and 26 by link 46.

In one preferred embodiment, the black ink container 28 and the corresponding black printhead 20 is replaceable as a separate unit referred to as a print cartridge represented by box 48 shown in dashed lines. In this preferred embodiment, the color ink containers 32, 34, and 36 are replaceable as one integral unit together with corresponding printheads 22, 24, and 26. The color ink containers 32, 34, and 36 and corresponding printheads 22, 24, and 26 form a tri-color ink cartridge 50, designated by a box shown in dashed lines. In this preferred embodiment, an information storage device 52 is associated with the black cartridge 48, and an information storage device 54 is associated with the color cartridge 50. A link 56 allows information to be transferred between the controller 44 and each of the information storage devices 52 and 54.

Information stored on the information storage devices 52 and 54 includes information relating to the particular ink parameters associated with their corresponding ink containers. For example, information storage device 52 contains information relating to the black ink container 28, and the information storage device contains information relating to each of the color ink containers 32, 34, and 36. This information includes, among other items, information relating to ink volume associated with the corresponding ink container. This information may include ink usage information such as a count of pixels generated for each ink container 28, 32, 34, and 36, initial ink volume, or current ink volume. The controller 44, utilizes the information on the information storage devices 52 and 54 to determine remaining ink volume.

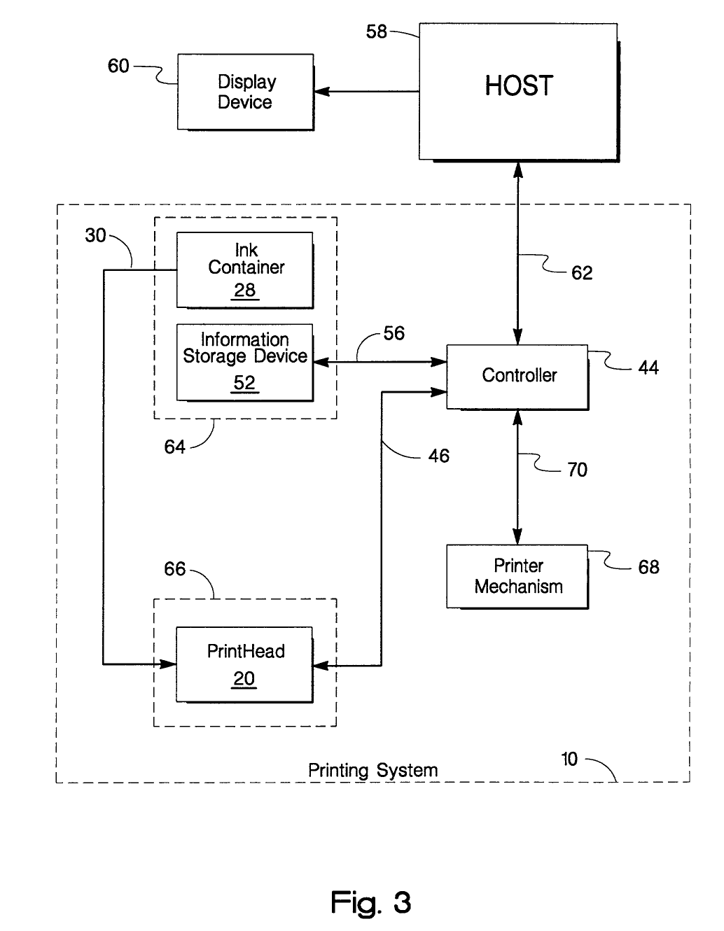

Although the preferred embodiment in FIG. 2 shows a configuration where the ink containers 28, 32, 34 and 36 are replaced with their corresponding printheads 20, 22, 24 and 26, other arrangements are also contemplated. For example, the ink containers 28, 32, 34 and 36 may be replaceable separate from their corresponding printheads 20, 22, 24, and 26, respectively as represented in an alternate embodiment shown in FIG. 3. In addition, each of the color ink containers 32, 34 and 36 may be replaceable individually, or these ink containers may be replaceable as a single integrated unit, having chambers for each individual ink color.

FIG. 3 represents a block diagram of the printing system 10 of the present invention shown connected to an information source or host computer 58. The host computer 58 is shown connected to a display device 60. The host 58 can be a variety of information sources such as a personal computer, work station, server, or a facsimile machine. In addition, the host 58 may be connected to one or more additional information sources through a network such as a network such as the internet or a local area network (LAN). The host 58 provides image information to the controller 44 by way of data link 62. The data link 62 may be any one of a variety of conventional data links such as an electrical link or infrared link for transferring information between the host 58 and printing system 10. In the case where the host 58 is a facsimile machine, the data link 62 is a conventional phone line.

The controller 44 is connected to the memory 52 associated with the black ink supply 28 by link 56. The controller 44 is also connected to the printhead 20 associated with black ink supply 28. Conduit 30 provides ink from the ink supply 28 to the printhead 20. It should be noted that, for simplicity, only the black ink supply 28 and black printhead are shown in FIG. 3. The color ink containers 32, 34, and 36, as well as corresponding color printheads 22, 24, and 26, respectively, have been omitted from FIG. 3 for simplicity. It should be also noted that a black ink container 28 and information storage device 52 are shown as a unit, indicated by box 64 shown in dashed lines, that is separately replaceable from the printhead 20. Similarly, the printhead 20 is shown as a separately replaceable unit indicated by box 66 shown in dashed lines. In this embodiment, when the ink container 28 is exhausted, the ink container and corresponding information storage device 52 are replaced, allowing the printhead 20 to be used until end-of-life. This embodiment shown in FIG. 3 is different from the embodiment shown in FIG. 2 where the printhead 20 and ink container 28 are replaced together as one unit.

The controller 44 is connected to a printer mechanism 68 by link 70. The printer mechanism controls media transport and movement of a scanning carriage for moving the printheads 20, 22, 24, 26, relative to print media as the printheads are selectively activated by the controller 44 to deposit ink on media to accomplish printing.

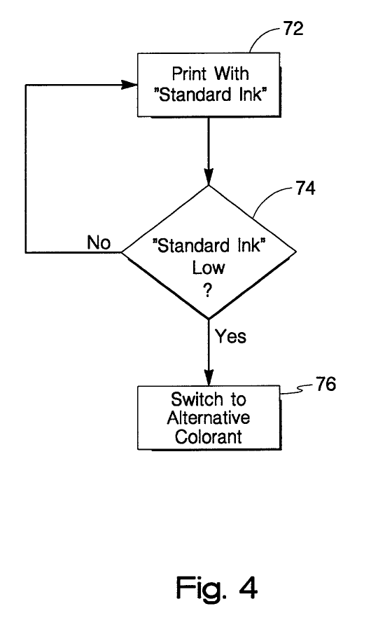

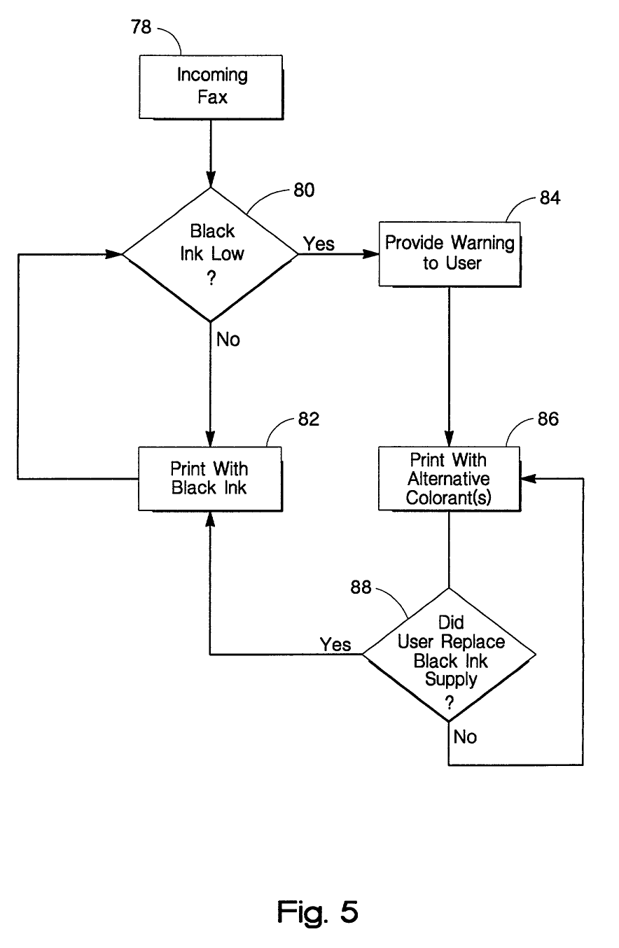

For the case where the host 58 is a facsimile machine, the controller 44 performs the corresponding facsimile receiving functions and receives the facsimile-encoded data on a phone line 62. Because the facsimile image is monochrome, the controller 44 converts this image data into proper commands to the printer mechanism 68 and the black printhead 20 to form this image on media. In the event that the black ink container 28 is exhausted of ink, the facsimile data is lost because the printhead 20 is activated but no ink is deposited on media. For the case where the printing system controller 44 has a memory associated therewith, once the controller 44 determines an out-of-ink condition has occurred, the facsimile data can be stored in this memory. However, because of the expense of semiconductor memory, even in the case where storage is possible, this storage is very limited and only postpones the inevitable that data will be lost when an out-of-ink condition has occurred. The technique of the present invention which is performed by the controller 44 for preventing the loss of data upon an out-of-ink condition will now be discussed with respect to FIGS. 4 and 5.

FIG. 4 depicts the method of the present invention. Upon the receipt of monochrome images such as facsimile images, the controller 44 selects a standard monochrome ink such as black ink. To accomplish this, the controller 44 activates the black printhead 20 as the printer mechanism 68 moves the printhead relative to print media. The printing system 10 prints these monochrome images using the standard ink until the standard ink is exhausted as represented by step 74.

Upon the detection of an out-of-ink condition the controller 44 then selects an alternative colorant as represented by step 76. This alternative colorant can be one or more of the color inks such as cyan, magenta, or yellow. The controller 44 activates the printheads 22, 24, or 26 to select any one of these alternative colorants. In one preferred embodiment, the controller 44 prints each of the cyan, magenta, and yellow colorants or inks to form a composite black image on media.

By selecting an alternate colorant, the printing system 10 of the present invention prevents image data from being lost due to an out-of-ink condition. In the case where the printing system 10 is unattended, such as when used to receive facsimile encoded data or when connected through the host 58 to a network, or where the controller 44 is directly connected to a network such as a local area network, image data may be routed to the printing system 10 without anyone attending the printer 10 to notice an out-of-ink condition. In this case, image data routed to the printing system 10 can be lost. The technique of the present invention prevents this loss of image data by overriding the specified colorants. In the case of text data or facsimile data, the printed information is very useful if printed using a different colorant.

In one preferred embodiment shown in FIG. 5, the printing system 10 is configured to receive facsimile encoded data. Upon receipt of an incoming facsimile as represented by step 78, the controller 44 checks to see if the black ink is low or exhausted. The controller determines a low ink condition by either computing ink usage, retrieving ink usage information from the information storage device 52 or by directly measuring the ink using a sensor. In the event that a low ink warning is not present, the facsimile encoded data is used to print an image with black ink as represented by step 82.

In the event that a low ink condition for the black ink is identified, a warning is displayed as represented by step 84. This warning can be indicated on a display associated with the printing system 10. Alternatively, the printing system 10 can print a low-ink warning in some color other than black ink such as red or another ink combination. Another alternative is to vary the colorants used in the printed image to catch the user's attention that the black ink cartridge is low.

For example, text characters can be formed that are partially red and partially black which would be immediately noticeable to the reader of the document, thereby prompting them to change the black ink cartridge. As represented by step 86, the controller 44 then checks to see if the black ink supply 28 has been replaced as represented by step 88. If the black ink supply has been replaced, printing with black ink resumes. If the black ink supply has not been replaced, the printing system 10 continues to print using alternative colorants. These alternative colorants include a combination of black and composite black for the condition where the black ink is very low but not completely depleted.

The present invention has been described herein as being implemented using hardware devices such as custom integrated circuits or some form of programmable logic by which the controller 44 performs these functions. Alternatively, the present invention can be implemented in software that runs on a microprocessor. In that case, the controller 44 contains program memory for providing instructions to the microprocessor to perform the functions described herein. Similarly, the controller 44 can be implemented in a programmable controller, or the host device 58 can be used to perform these functions of controller 44.

The printing system of the present invention provides a reliable way to prevent the loss of information such as facsimile encoded data. The present invention is particularly well-suited to facsimile applications where it is critical that faxes or fax data not be lost, by utilizing an alternative colorant upon an out-of-ink condition, data loss is prevented.

What is claimed is:

1. An inkjet printing device responsive to color description information for depositing colorants corresponding the color description information on print media, the colorants selected from a plurality of colorants associated with the inkjet printing device, the inkjet printing device comprising:
a determination device for detecting an out-of-ink condition indicative of an exhaustion of one or more of the plurality of colorants; and
a control device responsive to the occurrence of the out-of-ink condition for depositing a colorant, different from the selected colorants, to be deposited on print media.

2. The inkjet printing device of claim 1 wherein the plurality of colorants are black, cyan, yellow and magenta inks and wherein the color description information specifies a black color and wherein the selected colorant is black ink and wherein upon the determination that the black ink is exhausted the control device selects cyan, magenta, and yellow ink to be deposited on print media to form a composite black image on print media.

3. The inkjet printing device of claim 1 wherein the plurality of colorants are black, cyan, yellow and magenta inks wherein the color description information specifies a black color and wherein the selected colorant is black ink and wherein upon the determination that the black ink is exhausted the control device selects at least one ink from the cyan, magenta, and yellow inks to be deposited on print media to form an image.

4. The inkjet printing device of claim 1 wherein the inkjet printing device is configured for unattended operation wherein the inkjet printing device receives color description information and forms images on print media without local intervention.

5. The inkjet printing device of claim 1 wherein the control device includes a facsimile control portion for receiving facsimile encoded data, the facsimile control portion upon the receipt of facsimile encoded data formats this data for the inkjet printing device for forming images on media.

6. The inkjet printing device of claim 5 wherein the plurality of colorants are black, cyan, yellow and magenta inks and wherein upon receipt of facsimile encoded data and upon the determination that the black ink is exhausted the control device selects cyan, magenta, and yellow ink to be deposited on print media to form a composite black image.

7. A multifunction device responsive to image descriptions from a host device for printing color images and responsive to facsimile encoded data for printing black images, the multifunction device comprising:
a determination device for detecting an out-of-ink condition indicative of exhaustion of black colorant; and
a control device responsive to receipt of facsimile encoded data for forming images on media, the control device forming images with black colorant if the out-of-ink condition is not present and forming images of colorants other than black colorant if the out-of-ink condition is present.

8. The multifunction device of claim 7 wherein the control device upon receipt of facsimile encoded data when the out-of-ink condition is present images are formed with cyan, magenta and yellow colorants.

9. The multifunction device of claim 7 wherein the control device upon receipt of facsimile encoded data when the out-of-ink condition is present images are formed with at least one of cyan, magenta and yellow colorants.

10. A method for operating an inkjet printing system having both black ink and color ink for forming images on media, the method comprising:
receiving image data associated with an image to be printed;
determining the presence of an out-of-ink condition;
selecting an alternate color ink in response to presence of the out-of-ink condition, the alternate color ink being different from a color ink associated with the image data; and
printing the image data using the alternate color ink.

11. The method for operating an inkjet printing system of claim 10 wherein receiving image data is receiving facsimile encoded data and wherein black ink is the color ink associated with the facsimile encoded data and wherein the alternate color ink is at least one of the magenta, cyan and yellow ink.
